(19) United States
(12) Patent Application Publication
(10) Pub. No.: US 2013/0179841 A1
(43) Pub. Date: Jul. 11, 2013

(54) System and Method for Virtual Touring of Model Homes

(71) Applicants: Jeremy Mutton, Calgary (CA); Christopher Ritten, Calgary (CA); Jason Ritten, Calgary (CA)

(72) Inventors: Jeremy Mutton, Calgary (CA); Christopher Ritten, Calgary (CA); Jason Ritten, Calgary (CA)

(21) Appl. No.: 13/735,656

(22) Filed: Jan. 7, 2013

Related U.S. Application Data
(60) Provisional application No. 61/583,562, filed on Jan. 5, 2012.

(51) Int. Cl. G06F 3/0481

(52) U.S. Cl. CPC G06F 3/04815
USPC 715/850

(57) ABSTRACT

There is disclosed a system and method for providing a virtual tour of a model property. In an embodiment, a computer-implemented method comprises providing one or more interactive three dimensional viewing modes for viewing the model property. An interactive user control is provided for moving between the one or more interactive three dimensional interactive viewing modes, wherein, the transition between one or more interactive three dimensional viewing modes is continuous. The one or more interactive three dimensional viewing modes may include a floor plan view mode, and a three dimensional room view mode, with a seamless transition in between giving the viewer a sensation of zooming into or out of a selected room. In another embodiment, an interactive first person walk-through view mode is provided whereby a user can interact with one or more features in a room. The user is able to modify a design of one or more features in the model based upon preferences of the user.

### FIELD

The present disclosure relates to a system and method for providing a virtual tour of model homes, and more particularly towards providing users with improved interactive controls and viewing options.

### BACKGROUND

When a property developer wishes to present a model of one or more of their homes to prospective buyers, conventional methods have typically included showing floor plans, displaying representative samples of various finishing options, and in larger developments building one or more physical models that prospective buyers can tour, either as completed model homes, or as temporary mock-ups built in a display center. While such real-world models are ideal for showing prospective buyers what they can expect, it is often not possible to show all different models, floor plans, elevations, and different finishes that may also be offered by the property developer, either from a catalog, or available as a custom built option.

Prior art systems for providing basic modeling of homes that can be viewed as virtual three dimensional (3D) images are known, but, the available options for viewing are typically rudimentary and often limited to predetermined views and images. What is needed is an improved system and method for providing a virtual tour of model homes to prospective buyers.

### SUMMARY

The present disclosure relates to a system and method for taking a virtual tour of model homes, and more particularly towards interactive controls and viewing options available during a virtual tour.

In an aspect, there is provided a system and method for providing a virtual tour of a model property. In an embodiment, a computer-implemented method comprises providing one or more interactive three dimensional viewing modes for viewing the model property. An interactive user control is provided for moving between the one or more interactive three dimensional interactive viewing modes, wherein, the transition between one or more interactive three dimensional viewing modes is continuous. The one or more interactive three dimensional viewing modes may include a floor plan view mode, and a three dimensional room view mode, with a seamless transition in between giving the viewer a sensation of zooming into or out of a selected room. In another embodiment, an interactive first person walk-through view mode is provided whereby a user can interact with one or more features in a room. The user is able to modify, a design of one or more features in the model based upon preferences of the user.

In this respect, before explaining at least one embodiment of the system and method of the present disclosure in detail, it is to be understood that the present system and method is not limited in its application to the details of construction and to the arrangements of the components set forth in the following description or illustrated in the drawings. The present system and method is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 shows a schematic block diagram of an illustrative system in accordance with an embodiment.

FIG. 2 illustrates a generic computer system which may provide a suitable operating environment for various embodiments.

FIGS. 3-16 show a series of screen captures illustrating various features of the present system and method in accordance with an embodiment.

### DETAILED DESCRIPTION

As noted above, the present disclosure relates to a system and method for taking a virtual tour of model homes, and more particularly towards interactive controls and viewing options for a virtual tour.

As will be explained in more detail below, the present system and method provides a prospective buyer with a virtual tour of a model home which the prospective buyer can interactively control, and modify based upon preferences of the prospective buyer. In a preferred embodiment, the prospective buyer can readily move to different parts of a model home that he/she wishes to see and can modify the model to one or more optional elevations. The prospective buyer is also given the ability to change colors and finishes of different rooms in the virtual model home to complete customization of each room of the virtual model home for viewing. By providing interactive virtual 3D models of various homes that a user can readily navigate to visualize what they may be buying, the present system and method provides prospective buyers with a better basis to consider different options and make an informed purchasing decision.

The present system and method also allows complete 3D virtual models of custom homes to be built to specification of a prospective buyer and explored interactively. Thus, prospective buyers can visualize various design options and consider different design scenarios before making purchasing decisions. Custom property developers can thus save time and cost by reducing the number of last minute changes requested by a buyer as a custom home is being designed and built.

In another embodiment, the present system and method may provide access via an Internet website. By allowing 3D virtual model homes to be explored via the Internet, the present system and method also allows prospective buyers located virtually anywhere to explore different design options without having to visit a property developer's presentation center. The convenience of being able to access these virtual models at any time from virtually anywhere may create more interest in a property developer's design offerings.

Various aspects of the present system and method will now be described with reference to the figures.

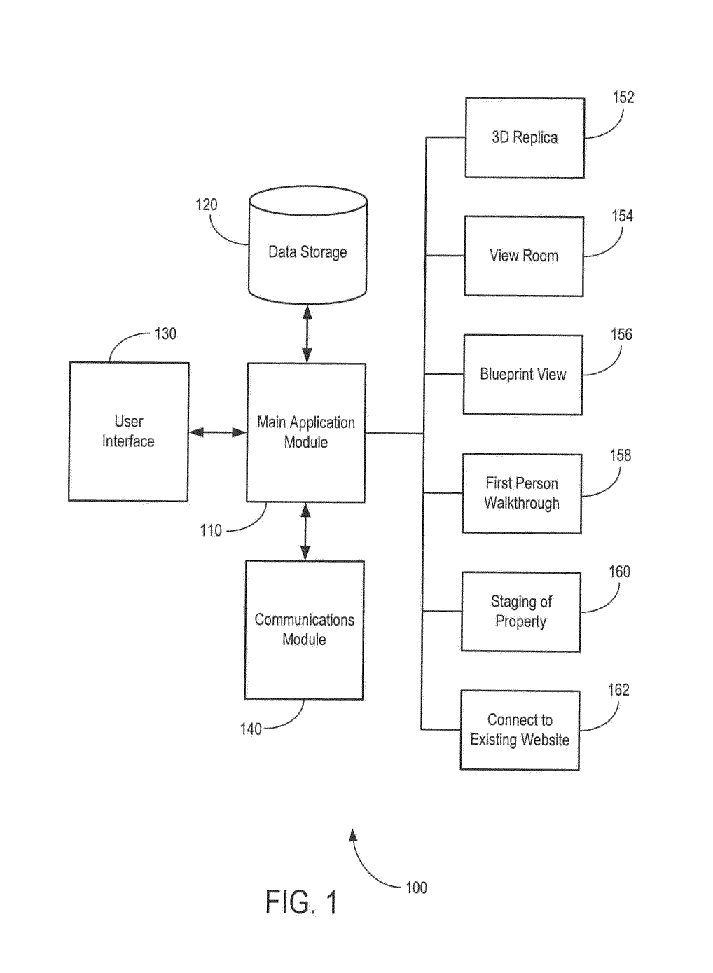

FIG. 1 shows an illustrative system 100 in accordance with an embodiment. System 100 includes a main application module 110, which is operatively connected to a data storage 120, a user interface 130, and a communications module 140. In an embodiment, system 100 includes a number of viewing modes, including a 3D replica of property mode 152, a room view mode 154, a blueprint view mode 156, a first person walk-through view mode 158, a property staging view mode 160. Each of these viewing options/modes is described in more detail further below.

Main application module 110 is adapted to run the main application and also control any modules or routines necessary for the system to function. Data storage 120 may store relevant data about one or more property designs, and various design options that may be available for each property design. Data storage 120 may also contain decision trees to determine which options to select based on a user's preferences, or based on demographic data entered by a user. Data storage 120 may store any other data necessary for operation of one or more embodiments of the system and method as described below. User interface may be a suitable graphical user interface (GUI) which allows a user to interact with the system 100, and also view graphically one or more property designs and various design options as may be selected by the user. Communications module 140 allows system 100 to be connected to a network, such as the Internet, for access to various other systems and servers (e.g. the websites for various suppliers and sponsors), and to allow access to the system 100 from virtually anywhere, via the Internet. For this purpose, system 100 may be developed to be integrated into existing websites and databases that property developers may already have. Main application module 110 may interact with website servers, or alternatively may be executed as an app directly from the system 100 (e.g. on a mobile device such as a smart phone or tablet).

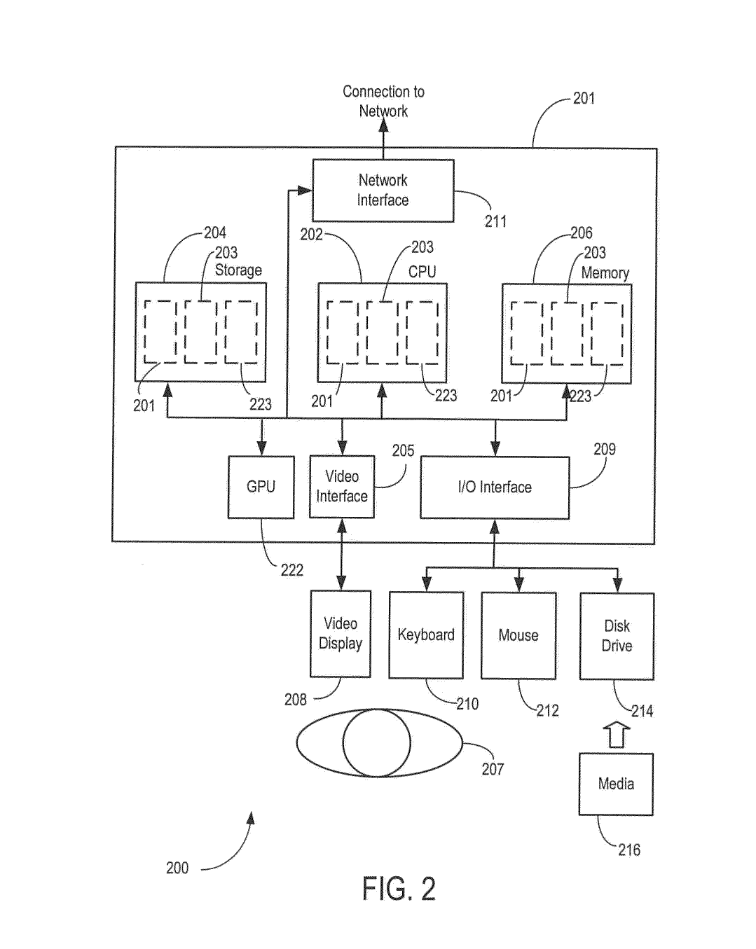

The present system and method may be practiced in various embodiments. A suitably configured computer device, and associated communications networks, devices, software and firmware may provide a platform for enabling one or more embodiments as described above. By way of example, FIG. 2 shows a generic computer device 200 that may include a central processing unit (“CPU”) 202 connected to a storage unit 204 and to a random access memory 206. The CPU 202 may process an operating system 201, application program 203, and data 223. The operating system 201, application program 203, and data 223 may be stored in storage unit 204 and loaded into memory 206, as may be required. Computer device 200 may further include a graphics processing unit (GPU) 222 which is operatively connected to CPU 202 and to memory 206 to offload intensive image processing calculations from CPU 202 and run these calculations in parallel with CPU 202. An operator 207 may interact with the computer device 200 using a video display 208 connected by a video interface 205, and various input/output devices such as a keyboard 210, mouse 212, and disk drive or solid state drive 214 connected by an I/O interface 209. In known manner, the mouse 212 may be configured to control movement of a cursor in the video display 208, and to operate various graphical user interface (GUI) controls appearing in the video display 208 with a mouse button. The disk drive or solid state drive 214 may be configured to accept computer readable media 216. The computer device 200 may form part of a network via a network interface 211, allowing the computer device 200 to communicate with other suitably configured data processing systems (not shown).

Referring back to FIG. 1, a 3D replica of property mode 152 allows a complete 3D replica of a property interior to be built to specification and include customized details, such as replicas of kitchen and bathroom cabinets, railings, windows, doors, fireplaces and lighting fixtures.

Using the room view mode 154, a prospective buyer can zoom into a selected room in a floor plan as shown by a blueprint view mode 156 using navigational controls operable by the user. This blueprint view mode 156 can be used to show the floor plans for each level of a home in an elevated interactive view.

For example, while viewing a floor plan of a level of a home, the prospective buyer (user) may be may wish to visualize the architectural features in the living room. In this case, the user may navigate to the living room in the floor plan using a mouse or track pad and click on the living room to zoom in. Alternatively, if the image is on a touch sensitive display screen, the user can touch the living room in order to zoom in. System 100 then utilizes the room view mode 154 to display a 3D representation of one of the rooms.

In an embodiment, system 100 provides the user with the impression of flying into the selected room until a virtual 3D image of the room fills the screen in a first person view. This visual continuity from the floor plan view to the 3D view of a room allows the user to confirm that they are in fact entering the room they selected to view more closely.

Once system 100 zooms into a selected room, system 100 may then execute a first person walk-through view mode 158 which allows the user to interactively explore the virtual room. In this mode, the user can navigate through the room via navigation controls such as arrow keys, a mouse, a tracking ball, a track pad, or joystick, for example. If using a touch sensitive display, the user may use swiping motions on the screen to look left, right, up or down, and also use motion controls to move within the virtual room.

Once within a selected room, the user may be provided with various options for customizing the view of the room using the property staging mode 160. As an illustrative example, in a great room, the user may have the option to change the design of the fireplace from several different options; and in the kitchen, the user may have the option to select stainless steel appliances and change the cabinets. The user may also select from a number of staging options based on color and style guidelines provided by the builder, or which the user may select themselves based on a color scheme or type of interior design which appeals to the user. For example, the user may be able, to view the room in a “country” style, a “classic” style, or a “modern” style, with each style showing different wall colors, different furniture, and different accessories such as virtual couches, TVs, tables, beds, dressers, pictures, etc.

In another embodiment, system 100 is configured to control all aspects of lighting to provide a flattering appearance for each room. System 100 may use various interior lighting options and also model daylight through windows to show what a room may look like at different times of the day or night.

In an embodiment, system 100 may be configured to display a stereoscopic 3D image of the room which may be viewed with stereoscopic 3D glasses, such that the user's experience in viewing the virtual model is further enhanced with the sensation of depth. This 3D stereoscopic view may be used for any one of the various viewing modes, 152-160, in order to provide the user with the sensation of depth when viewing the virtual models.

In an embodiment, system 100 can also generate a 3D view of the exterior of a home, including the landscaping. Thus, system 100 may show an illustrative back yard with customization of everything from the placement of trees and bushes, to deck and fence options, retaining walls and pools. The back yard can also be staged with patio furniture, barbeques parking pads, garages, etc.

In an embodiment, system 100 may be utilized to generate 3D virtual models based on existing blueprint files, such as the AutoCAD files, for each property. Input from the developer/interior design teams may be required to provide the customization options available to the user, but system 100 may already have many different design options modeled and stored in data store 120 to be made available based on the developer/interior designer specifications. The types of models that may be developed may include single and multi-family properties, town properties, condos, apartment complexes, retail buildings, commercial properties.

In an embodiment, the property developer can give a client a better sense of the progress being made at different stages of construction. For example, a virtual model may show a property at different stages of construction, such as framing, plumbing, electrical, drywall, finishing stages etc. This enables the property developer to show a representation of the work that has been or will be completed at each stage, giving buyers a better sense of being involved in the construction of their property without having to be onsite.

In another embodiment, system 100 may be configured to select amongst different viewing options based on the demographic input from a user. For example, the options may be set up with predetermined colors, decor and features specific to the user's demographics. System 100 is configured to receive answers to specific queries, such as the user's age, marital status, ages and the number of children, etc. Thus, if a user has a family with two children, system 100 can select neutral colors for the rooms with the children's bedrooms staged in pink and blue with a play structure in the back yard. Alternatively, if the user is a bachelor, the property can be staged in darker colors and a games room can replace a family room.

Various screen captures of system 100, as may be presented via the user interface 130 on a video display 208, for example, will now be described to illustrate the features as discussed above.

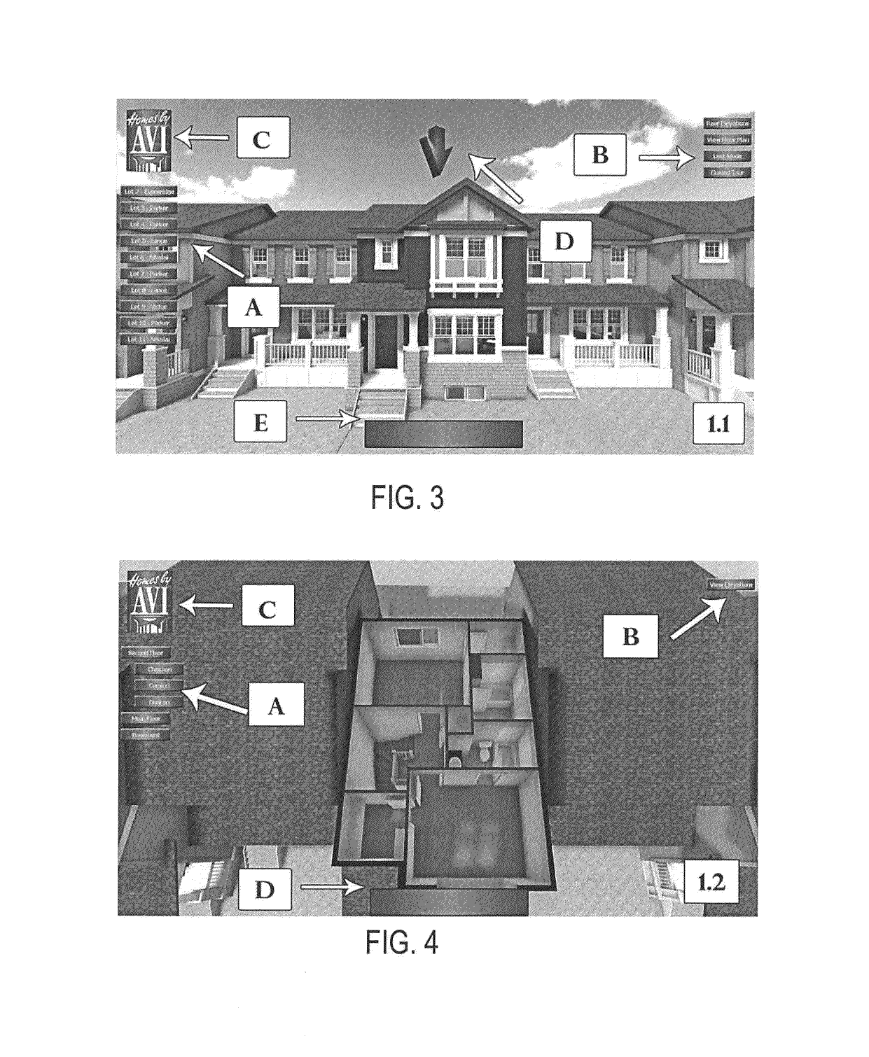

In FIG. 3, shown is an elevation view of a property in it neighborhood. In FIG. 3, buttons (A) at the left of the screen allow a user to select different properties to view. Navigation buttons (B) are displayed at the top right corner of the screen, and some viewing options include: Rear elevation, View floor plans, User mode, and Guided tour. A property developer's logo (C) is shown at the top left of the screen. An arrow icon (D) shown above a property indicates which property the user is presently viewing. A description box (E) also displays which property and floor plans the user is viewing.

Now referring to FIG. 4, shown is an illustrative floor plan view of a level of a property. As will be observed, even the floor plan view shows the level in a perspective view with walls showing windows and doors and partially hiding the features of some of the rooms. The screen displays buttons (A) for selecting floor plans for different levels of the property. Once a level is selected, multiple viewing options may be presented. This feature allows users to select a room to zoom in to for a more interactive view, as previously described. All floor plan options may be displayed in an interactive elevated view of the 3D model, and the 3D models change to match the selection of the floor plan. In an embodiment, the top of each floor plan is bolded to show the floor plan overtop of the 3D model.

Still referring to FIG. 4, a View elevations button (B) may be used to bring the user back to the main exterior elevations screen shown in FIG. 3. The builder's logo (C) is shown to identify the builder, and a description box (D) displays which property and floor plans the user is currently viewing.

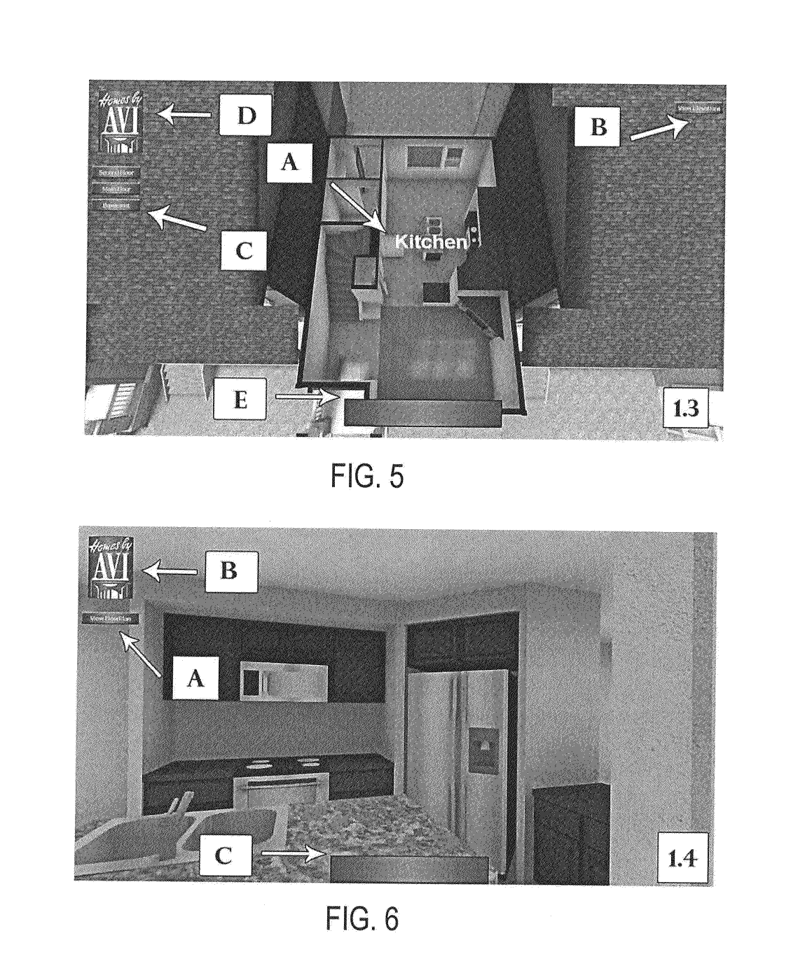

Now referring to FIG. 5, shown is a floor plan with a room highlight. In this illustrative example, when a cursor is moved over the floor plans to a room (A), an area highlight appears including the name of the room, and description of the room dimensions. Clicking a designated mouse button while an area is highlighted activates a zoom view into the selected room for a close up 3D view of the area. Thus, this feature shows the property floor plans in an elevated interactive view, and also allows users to pick a room to zoom in on for a close up 3D interactive view. Every floor is represented in the floor plan view including basements.

Now referring to FIG. 6, shown is a room view of a selected room for a close up view of the area. A View floor plan button (A) takes the user back to the floor plan view. Each room may provide an option to customize room specific features. For example, as described earlier the user may change appliances and cabinets to view the room with different possible options. In an embodiment, a mouse may be used to navigate the view. For example, holding the right mouse button and moving the mouse enables the user to move the direction of view. This view can look in all directions while staying positioned in one location. When the right mouse button is released, the camera returns to the original starting position. Users can also look around using arrow buttons that appear on each side of the screen.

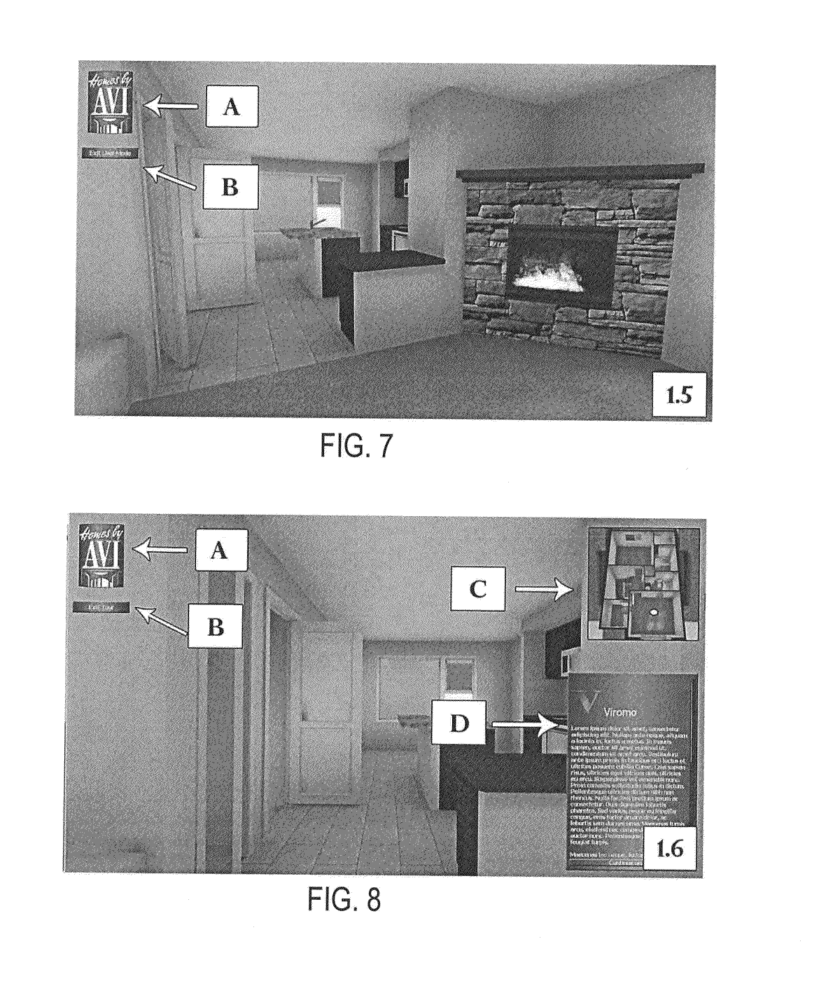

Now referring to FIG. 7, shown is an illustrative example of a first-person walk-through view in which system 100 allows a user to navigate to a different position in the virtual room. For example, by holding the right mouse button and moving the mouse, the user can move the direction of view. When the mouse button is released the view returns to looking straight ahead. In this example, the user may also navigate to a different position in the room, for example by using arrow keys or designated letter keys.

Now referring to FIG. 8, shown is an illustrative guided view mode, in which system 100 guides the user through a prepared, guided tour of the property. In this mode, rather than navigating through the property, the user may allow system 100 to take the user through a guided tour as if the user is being taken through the property by a sales representative. An Exit tour button (B) allows the user to exit the screen and return to an elevations view, or a floor plan view as the case may be. In an embodiment, a mini map (C) shows users their current location in the property. A display (D) shows information that the property developer may wish to showcase to prospective buyers. It will be appreciated that the information is viewable in many different ways, including pop-up screens, static page inserts, embedded virtual displays, or information showcases. In an embodiment, guided tours may contain voice actors reading the information in addition to or in place of the text displayed in display (D). After reading the information, the user can click on continue, or advance, to view a new room with new information.

Thus, guided tours can take prospective clients on a walkthrough of the property showing key design elements, upgrade features, and anything else the property developer would like their clients to learn. For example, clicking on an icon that rests over top of the counter top will bring up a window where clients can read about the counter top options and manufactures. As another example, an online marketing video may use the 3D model as a backdrop, and a voice actor may speak about features as a camera navigates throughout the property. This video may be a few minutes long, and move from room to room showcasing information about the property that the developer wants to get across to prospective buyers. The user may also have the option of controlling the speed of the guided tour, by being able to pause and linger in a particular room for a closer look before proceeding further with the tour.

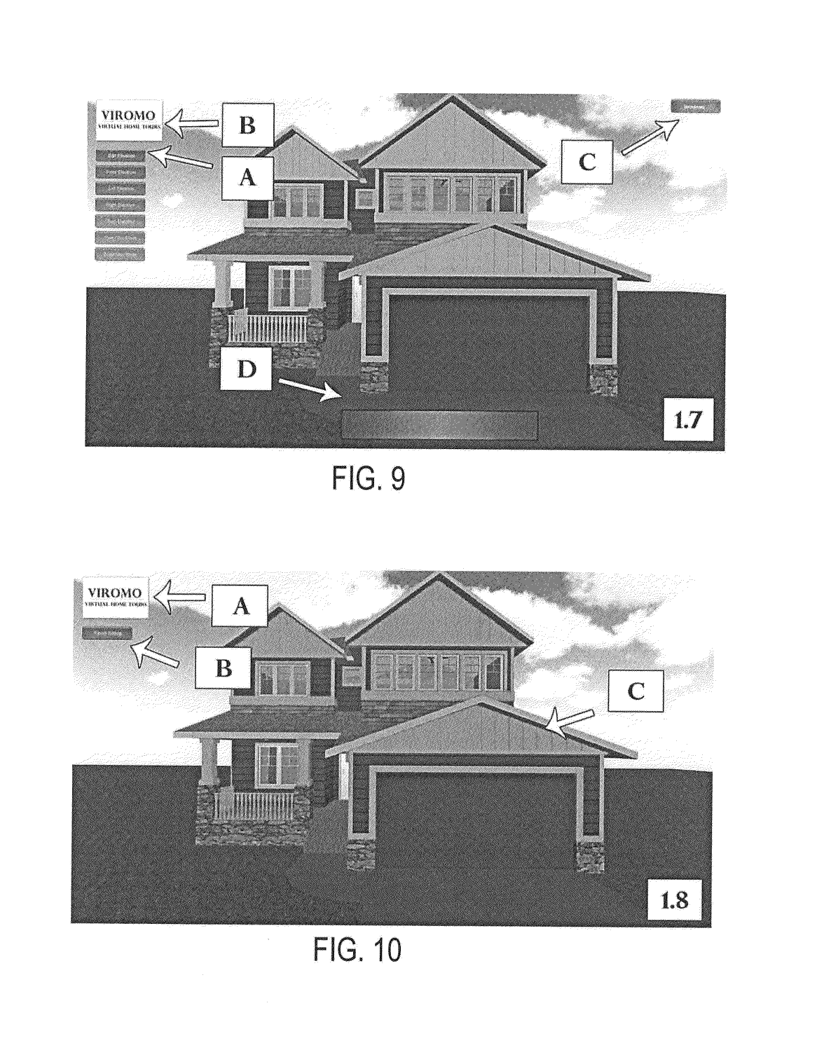

Now referring to FIG. 9, shown is an illustrative exterior elevation view which allows a user to edit the elevation using edit exterior buttons (A). For example, the user may also select the building materials used on the model. Material options may be displayed for selection in many ways, including data lists, thumbnail pictures, large pictures, information descriptions, links to products and websites, etc. Many different features of the property may be customized in this matter.

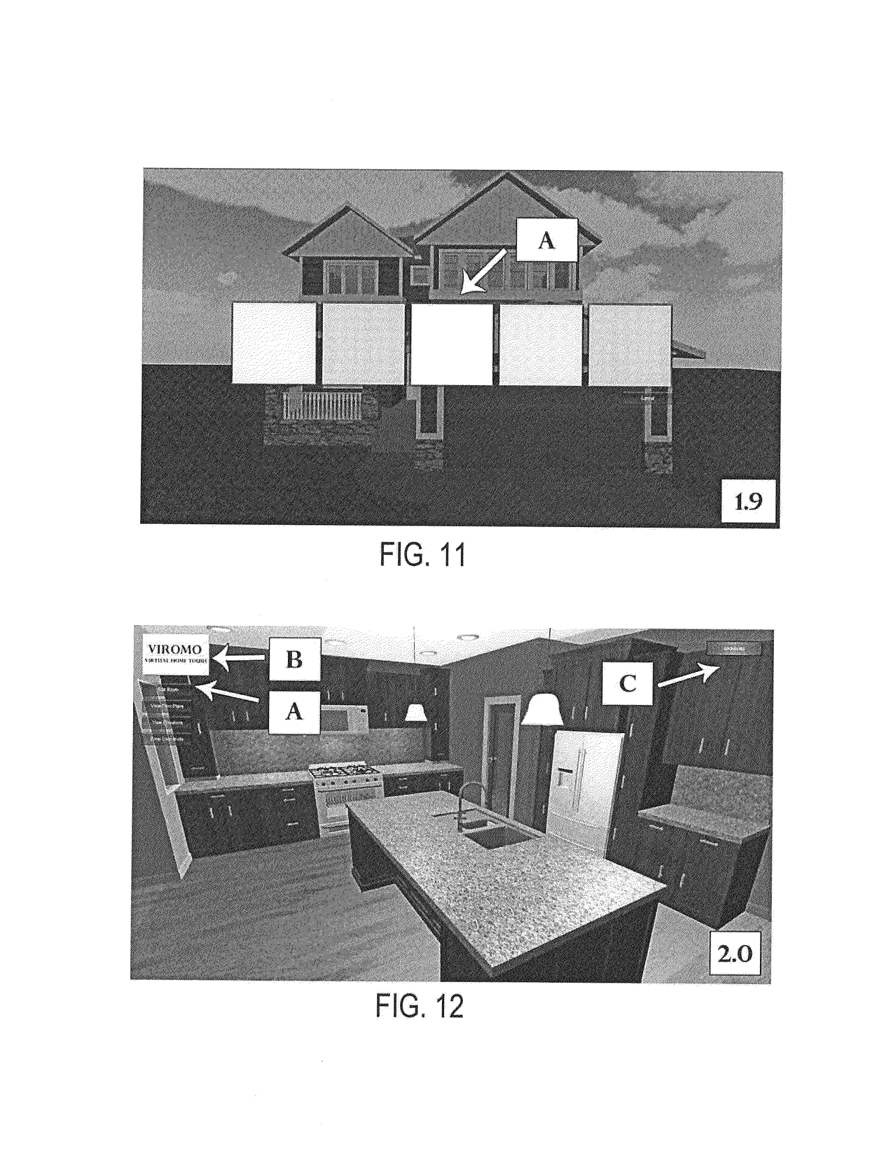

Now referring to FIGS. 10 and 11, shown are illustrative screens for editing the exterior with highlights. Moving a cursor (C) over the exterior of the property engages highlights in a different color from the original to indicate that the highlighted area can be edited. Areas that use the same materials will highlight together. Clicking M the highlighted area brings the user to a screen that displays available options for selection. Clicking on a desired material will select the material choice and immediately display it on the model. Once selection is made, the material selection window closes to show the elevations screen with new material selected. Material options may be displayed in many ways, including data lists, thumbnail pictures, large pictures, information descriptions, links to products and websites. A Finished editing button (B) brings the user back to the elevations view to review changes they have made.

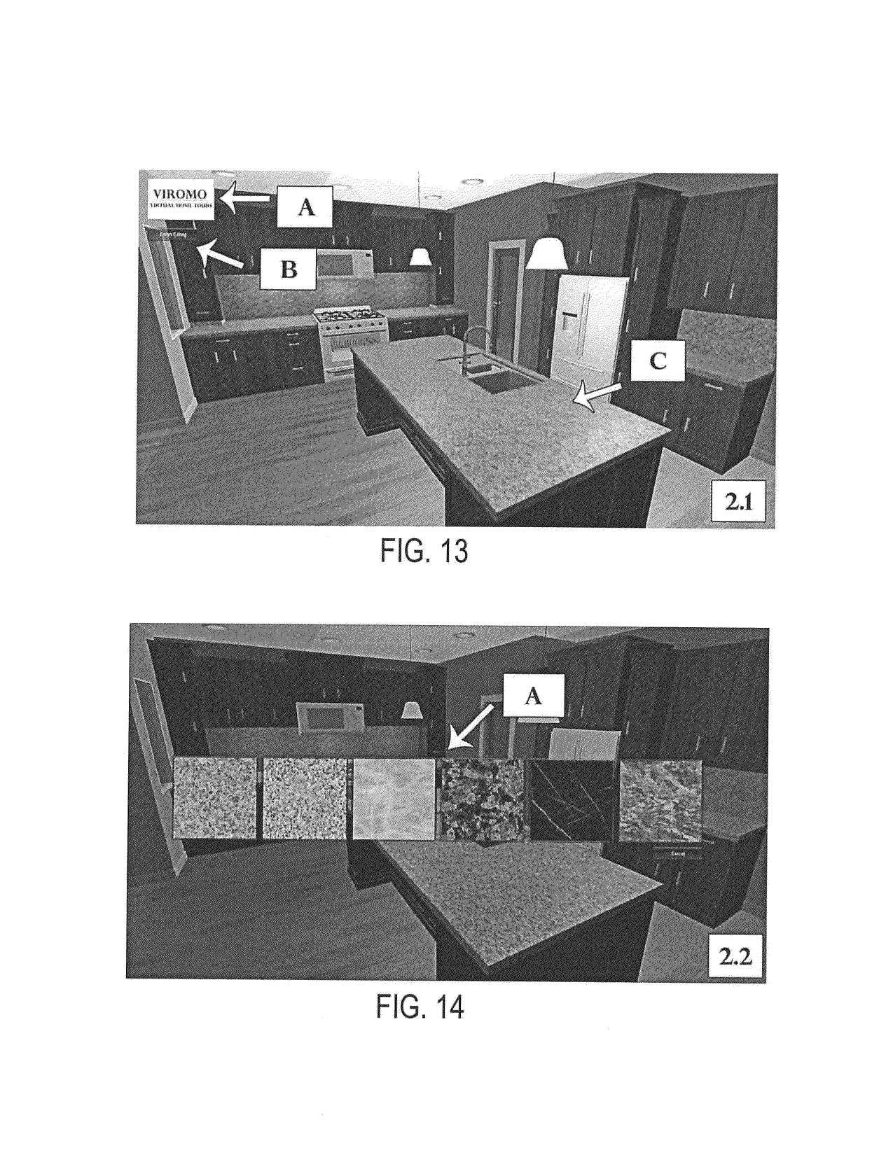

Now referring to FIGS. 12 to 14, shown is an edit interior screen in which an edit room button (A) enables a user to enter edit mode. In an embodiment, a sponsor/supplier/builder information button may bring the user to a sponsor screen for additional information. In an embodiment, holding the right mouse button enables the user to move the view. This view can look in all directions while staying positioned in one location. The user may move the cursor over various interior features until a highlighted area shows which features may be edited. Clicking on the highlighted area brings the user to a screen that displays options to edit the feature. Areas that use the same interior materials are highlight together. As shown by way of illustration in FIG. 14, material options may be displayed in many ways, including data lists, thumbnail pictures, large pictures, information descriptions, links to products and websites. Clicking a left mouse button on desired material will select material choice. The material choice is then immediately placed on model, Once the selection is made, the material selection window closes to show room view screen with new material visible.

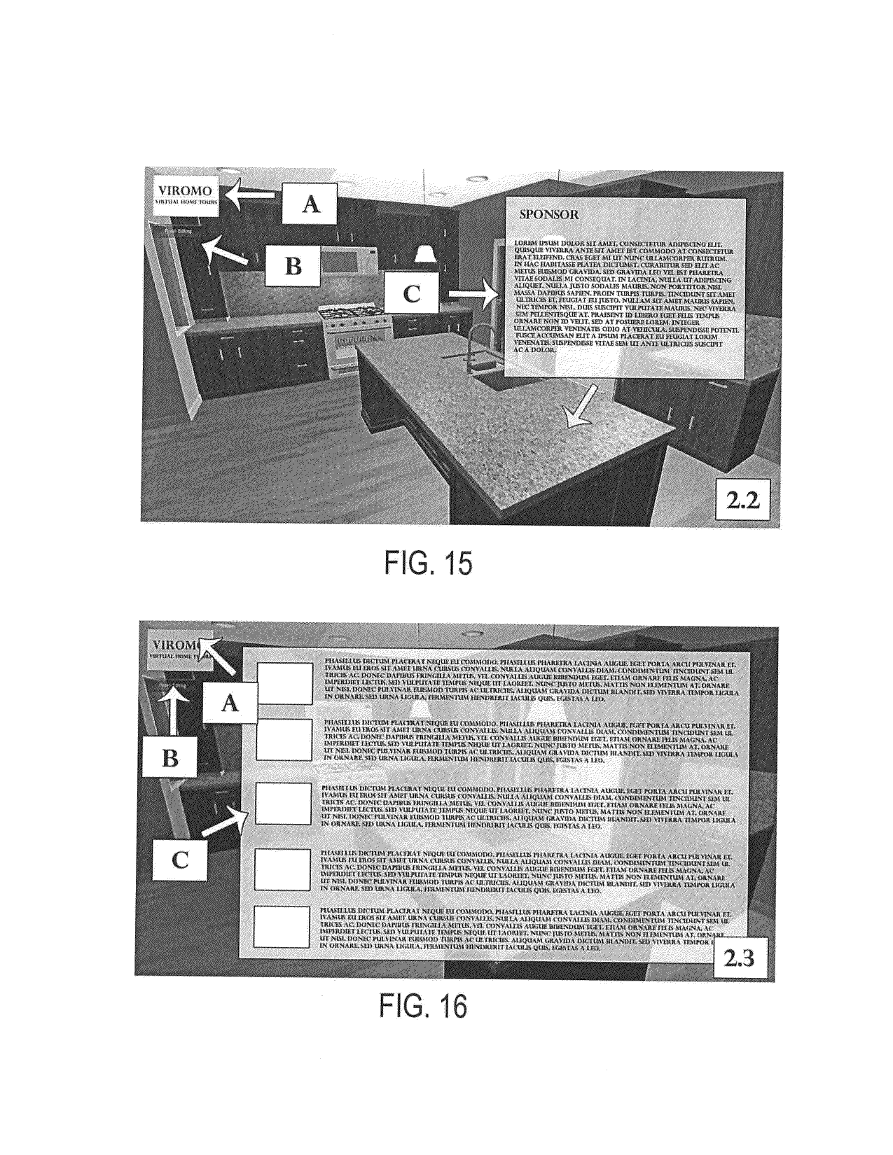

Now referring to FIG. 15, shown is an illustrative screen which can display sponsor information (C) for various features in the view. Clicking on a sponsor icon opens sponsor information window or links to sponsors website. This allows a property developer/builder to highlight and showcase their suppliers to demonstrate the quality of the property being developed.

Now referring to FIG. 16, shown is an illustrative example of a sponsor list in which sponsors/builders/suppliers are listed with logos and printed information. Clicking on icon will open a video window or links to the suppliers' respective websites. In an embodiment, suppliers may be given the option to highlight their products in the property. Once a supplier has been selected, their products will become highly visible using highlights, icons or arrows to showcase their products in the model home.

In summary, the present system and method provides a number of benefits to property developers and prospective buyers, including providing a clear picture of what a buyer's choices will look like, allowing the buyer to visualize their choice when an actual model is not build. The present system and method also allows buyers to have an input in the design, and to visualize how their selections may appear, either in the property interior, or the property exterior. By allowing a buyer to visualize their selections, the number of last minute changes may be reduced, allowing the property developer to save time and cost. Finally, the virtual model allows various sponsors/builders/suppliers to promote their products or services as part of the touring and customization process.

Thus, in an aspect, there is provided a computer-implemented method for providing a virtual tour of a model property, comprising: providing one or more interactive three dimensional viewing modes for viewing the model property; and providing an interactive user control for moving between the one or more interactive three dimensional interactive viewing modes, wherein, the transition between one or more interactive three dimensional viewing modes is continuous.

In an embodiment, one of the interactive three dimensional viewing modes is a floor plan view mode, and another of the interactive three dimensional viewing modes is a three dimensional room view mode.

In another embodiment, the method further comprises providing an interactive first person walk-through view mode with navigation controls, whereby a user can interact with one or more features in a room.

In another embodiment, the method further comprises providing a stereoscopic three dimensional (3D) image as the user navigates a virtual tour of a model property.

In another embodiment, the method further comprises providing an interactive control to modify a design one or more features based upon preferences of the user.

In another embodiment, the method further comprises providing a list of user selectable styles from which the user can select view a room in different styles.

In another embodiment, the method further comprises providing a list of user selectable lighting options which the user can select to view a room in different lighting.

In another embodiment, the method further comprises providing different viewing options based on a demographic input received from a user.

In another embodiment, the method further comprises accessing the virtual tour remotely via an Internet website.

In another aspect, there is provided a computer system for providing a virtual tour of a model, property, the system adapted to: provide one or more interactive three dimensional viewing modes for viewing the model property; and provide an interactive user control for moving between the one or more interactive three dimensional interactive viewing modes, wherein, the transition between one or more interactive three dimensional viewing modes is continuous.

In an embodiment, one of the interactive three dimensional viewing modes is a floor plan view mode, and another of the interactive three dimensional viewing modes is a three dimensional room view mode.

In another embodiment, the system is further adapted to provide an interactive first person walk-through view mode with navigation controls, whereby a user can interact with one or more features in a room.

In another embodiment, the system is further adapted to provide a stereoscopic three dimensional (3D) image as the user navigates a virtual tour of a model property.

In another embodiment, the system is further adapted to provide an interactive control to modify a design one or more features based upon preferences of the user.

In another embodiment, the system is further adapted to provide a list of user selectable styles from which the user can select view a room in different styles.

In another embodiment, the system is further adapted to provide a list of user selectable lighting options which the user can select to view a room m different lighting.

In another embodiment, the system is further adapted to provide different viewing options based on a demographic input received from a user.

In another embodiment, the system is further adapted to provide access to the virtual tour remotely via an Internet website.

In another aspect, there is provided a non-transitory computer readable media storing computer code that when executed on a computer device adapts the device to perform a method for providing a virtual tour of a model property, the non-transitory computer readable media comprising: code for providing one or more interactive three dimensional viewing modes for viewing the model property; and code for providing an interactive user control for moving between the one or more interactive three dimensional interactive viewing modes, wherein, the transition between one or more interactive three dimensional viewing modes is continuous.

In an embodiment, one of the interactive three dimensional viewing modes is a floor plan view mode, and another of the interactive three dimensional viewing modes is a three dimensional room view mode.

While various illustrative embodiments of the system and method have been described above, it will be appreciated that various changes may be made without departing from the scope of the invention.

1. A computer-implemented method for providing a virtual tour of a model property, comprising:
providing one or more interactive three dimensional viewing modes for viewing the model property; and
providing an interactive user control for moving between the one or more interactive three dimensional interactive viewing modes, wherein, the transition between one or more interactive three dimensional viewing modes is continuous.

2. The computer-implemented method of claim 1, wherein one of the interactive three dimensional viewing modes is a floor plan view mode, and another of the interactive three dimensional viewing modes is a three dimensional room view mode.

3. The computer-implemented method of claim 1, further comprising providing an interactive first person walk-through view mode with navigation controls, whereby a user can interact with one or more features in a room.

4. The computer-implemented method of claim 3, further comprising providing a stereoscopic three dimensional (3D) image as the user navigates a virtual tour of a model property.

5. The computer-implemented method of claim 1, further comprising providing an interactive control to modify a design one or more features based upon preferences of the user.

6. The computer-implemented method of claim 1, further comprising providing a list of user selectable styles from which the user can select view a room in different styles.

7. The computer-implemented method of claim 1, further comprising providing a list of user selectable lighting options which the user can select to view a room in different lighting.

8. The computer-implemented method of claim 1, further comprising providing different viewing options based on a demographic input received from a user.

9. The computer implemented method of claim 1, further comprising accessing the virtual tour remotely via an Internet website.

10. A computer system for providing a virtual tour of a model property, the system adapted to:
provide one or more interactive three dimensional viewing modes for viewing the model property; and
provide an interactive user control for moving between the one or more interactive three dimensional interactive viewing modes, wherein, the transition between one or more interactive three dimensional viewing modes is continuous.

11. The computer system of claim 10, wherein one of the interactive three dimensional viewing modes is a floor plan view mode, and another of the interactive three dimensional viewing modes is a three dimensional room view mode.

12. The computer system of claim 10, wherein the system is further adapted to provide an interactive first person walk-through view mode with navigation controls, whereby a user can interact with one or more features in a room.

13. The computer system of claim 12, wherein the system is further adapted to provide a stereoscopic three dimensional (3D) image as the user navigates a virtual tour of a model property.

14. The computer system of claim 10, wherein the system is further adapted to provide an interactive control to modify a design one or more features based upon preferences of the user.

15. The computer system of claim 10, wherein the system is further adapted to provide a list of user selectable styles from which the user can select view a room in different styles.

16. The computer system of claim 10, wherein the system is further adapted to provide a list of user selectable lighting options which the user can select to view a room m different lighting.

17. The computer system of claim 10, wherein the system is further adapted to provide different viewing options based on a demographic input received from a user.

18. The computer system of claim 10, wherein the system is further adapted to provide access to the virtual tour remotely via an Internet website.

19. A non-transitory computer readable media storing computer code that when executed on a computer device adapts the device to perform a method for providing a virtual tour of a model property, the non-transitory computer readable media comprising:
code for providing one or more interactive three dimensional viewing modes for viewing the model property; and
code for providing an interactive user control for moving between the one or more interactive three dimensional interactive viewing modes, wherein, the transition between one or more interactive three dimensional viewing modes is continuous.

20. The non-transitory computer readable media of claim 19, wherein one of the interactive three dimensional viewing modes is a floor plan view mode, and another of the interactive three dimensional viewing modes is a three dimensional room view mode.
